(19) United States
(12) Patent Application Publication
(10) Pub. No.: US 2014/0285155 A1
(43) Pub. Date: Sep. 25, 2014

(54) POWER CONVERSION DEVICE HAVING BATTERY HEATING FUNCTION

(71) Applicant: SAMSUNG SDI CO., LTD., Yongin-si (KR)

(72) Inventor: Sun-Ho CHOI, Yongin-si (KR)

(73) Assignee: SAMSUNG SDI CO., LTD., Yongin-si (KR)

(21) Appl. No.: 14/185,286

(22) Filed: Feb. 20, 2014

(30) Foreign Application Priority Data
Mar. 20, 2013 (KR) 10-2013-0029833

(51) Int. Cl. H02J 7/02

(52) U.S. Cl. CPC H02J 7/027
USPC 320/130; 320/134

(57) ABSTRACT

A power conversion device includes a sensor and a controller, The sensor detects a predetermined condition. The controller controls heating of a battery when the predetermined condition is detected by the sensor. The controller controls heating of the battery based on at least one of a battery charging operation or a battery discharging operation.

### CROSS-REFERENCE TO RELATED APPLICATION

Korean Patent Application No. 10-2013-0029833, filed on Mar. 20, 2013, and entitled, “POWER CONVERSION DEVICE HAVING BATTERY HEATING FUNCTION,” is incorporated by reference herein in its entirety.

### BACKGROUND

1. Field

One or more embodiments descried herein relate to power conversion.

2. Description of the Related Art

Energy storage systems that efficiently store energy continue to be of interest to system designers. One type of energy storage system includes a battery for storing electric power from an external power source. The battery may then supply the stored power to an external load.

Several factors may adversely affect performance of the battery. For example, when the battery reaches a particularly low temperature (e.g., in an intensely cold region or during winter), the battery electrolytes do not quickly reach a proper operating state. As a result, the battery may malfunction.

### SUMMARY

In accordance with one embodiment, a power conversion device includes a converter including a first circuit coupled to a battery, a second circuit coupled to a DC link, and a transformer coupled between the first and second circuits; and a controller to control the converter to repeatedly perform charging and discharging operations for the battery in a battery heating mode.

Also, the device may include a temperature sensor to measure a temperature of the battery. The controller is to control performance of the battery heating mode based on the temperature measured by the temperature sensor. When the temperature of the battery measured by the temperature sensor corresponds to a predetermined reference value or more in the battery heating mode, the controller ends the battery heating mode.

Also, the first circuit may include a first inductor coupled to the battery; a first switch between the first inductor and a first node; a second switch between the first node and a reference power source; a third switch between the first inductor and a second node; and a fourth switch between the second node and the reference power source.

Also, the second circuit may include a fifth switch between the DC link and a third node; a sixth switch between the third node and the reference power source; a seventh switch between the DC link and a fourth node; and an eighth switch between the fourth node and the reference power source.

Also, a primary coil of the transformer may be between the first and second nodes, and a secondary coil of the transformer may be coupled between the third and fourth nodes.

Also, the first circuit includes a plurality of recovery diodes coupled in parallel to respective ones of the first through fourth switches, and the second circuit includes a plurality of recovery diodes coupled in parallel to respective ones of the fifth through eighth switches. Each of the first through eighth switches may include a transistor.

Also, the controller may perform turn-on and turn-off operations of the second and third switches while maintaining the first and fourth switches in a turn-on state, in order to perform a discharging operation of the battery during the battery heating mode.

Also, the controller may perform turn-on and turn-off operations of the sixth and seventh switches while maintaining the fifth and eighth switches in a turn-off state, in order to perform a charging operation of the battery during the battery heating mode.

Also, the controller may perform turn-on and turn-off operations of the first and fourth switches while maintaining the second and third switches in the turn-on state, in order to perform the discharging operation of the battery during the battery heating mode.

Also, the controller may perform turn-on and turn-off operations of the fifth and eighth switches while maintaining the sixth and seventh switches in the turn-off state, in order to perform the charging operation of the battery during the battery heating mode.

In accordance with another embodiment, a device includes a sensor to detect a predetermined condition, and a controller to control heating of a battery when the predetermined condition is detected by the sensor, the controller to control heating of the battery based on at least one of a battery charging operation or a battery discharging operation.

Also, the predetermined condition may include a predetermined temperature. The predetermined temperature may corresponds to a temperature of the battery or may correspond to an environment in which the battery is located. The environment temperature may be air or ambient temperature, or may be a temperature of another device coupled to or located proximate the battery. The temperature may correspond to one or a range of temperatures at which the battery is known to malfunction or underperform. The temperature may also be a temperature of a load coupled to the battery.

Also, the predetermined condition may be one of a voltage or current of the battery indicative of a malfunction or underperformance of the battery. The predetermined condition may also correspond to another type of error condition.

Also, the controller may control heating of the battery by alternatively performing the charging operation and the discharging operation at least once. The controller may control heating of the battery by repeatedly performing the charging operation and the discharging operation.

### BRIEF DESCRIPTION OF THE DRAWINGS

Features will become apparent to those of ordinary skill in the art by describing in detail exemplary embodiments with reference to the attached drawings in which:

FIG. 1 illustrates an embodiment of a power conversion device;

FIG. 2 illustrates an embodiment of a battery heating operation;

FIG. 3 illustrates an embodiment of a bidirectional; and

FIG. 4 illustrates an embodiment of an energy storage system employing a power conversion device.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

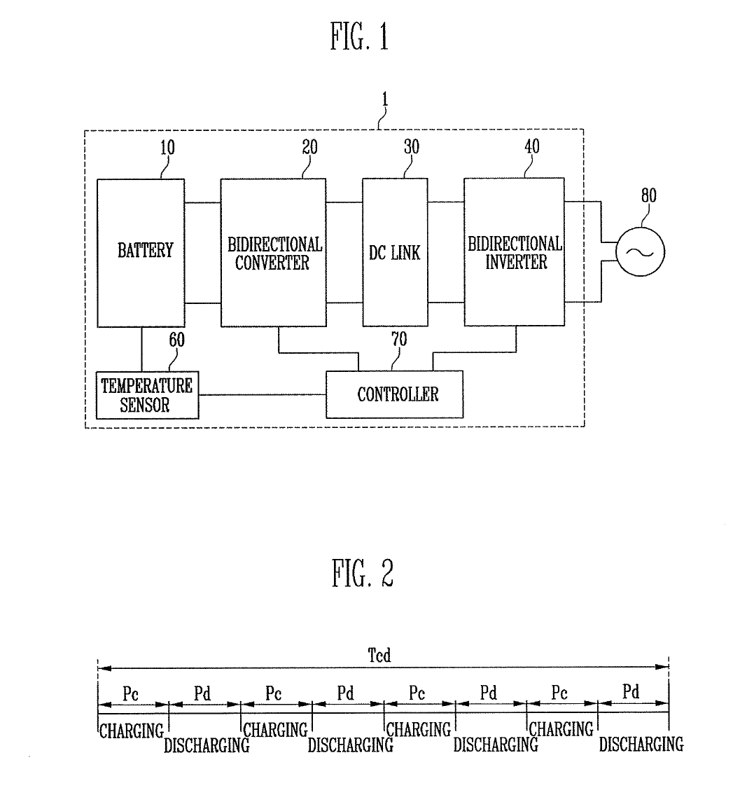

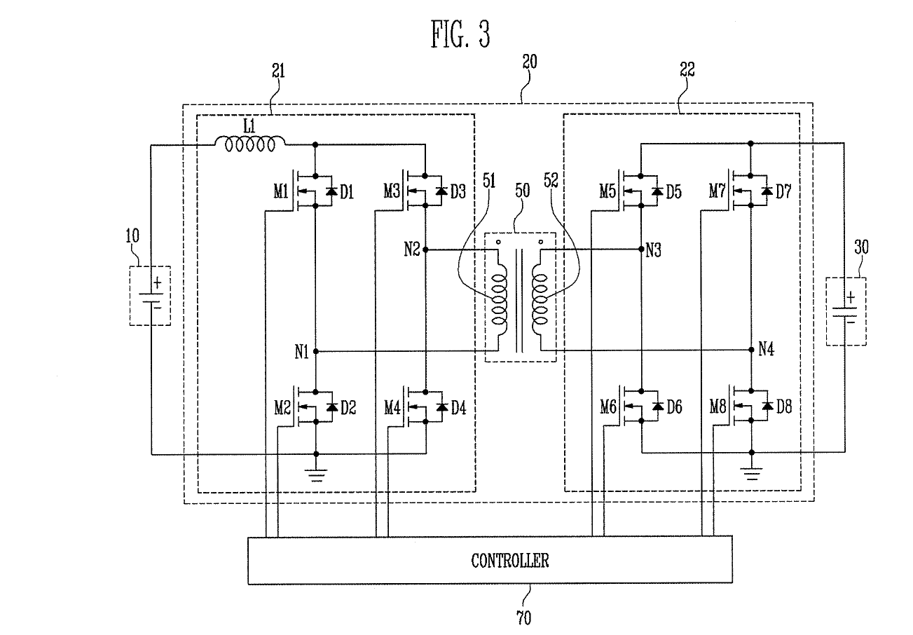

FIG. 1 illustrates an embodiment of a power conversion device, and FIG. 2 illustrates an embodiment of a heating operation for a battery included in the power conversion device. Referring to FIG. 1, the power conversion device 1 which performs a battery heating function (hereinafter, referred to as a power conversion device) includes a battery 10, a bidirectional converter 20, a DC link 30, and a controller 70.

The battery 10 may be any type of battery. In one embodiment, the battery may be a secondary battery which can be charged and discharged. For example, the battery 10 may be a nickel-cadmium battery, lead storage battery, nickel metal hydride battery (NiMH), lithium ion battery, or a lithium polymer battery, to name a few.

The bidirectional converter 20 is coupled between the battery 10 and the DC link 30. The bidirectional converter 20 may convert DC power received from the DC link 30 at a first level into DC power of a second level suitable for storage in the battery 10. The bidirectional converter 20 may transmit the converted DC power to the battery 10 over one or more power lines or connections.

The bidirectional converter 20 may also convert DC power received from the battery 10 at the second level into DC power of the first level suitable for the DC link 30. The bidirectional converter may transmit the converted DC power to the DC link 30 over one or more power lines or connections.

The bidirectional converter 20 may also generate a charging/discharging path of the battery 10, between the battery 10 and the DC link 30, under the control of the controller 70.

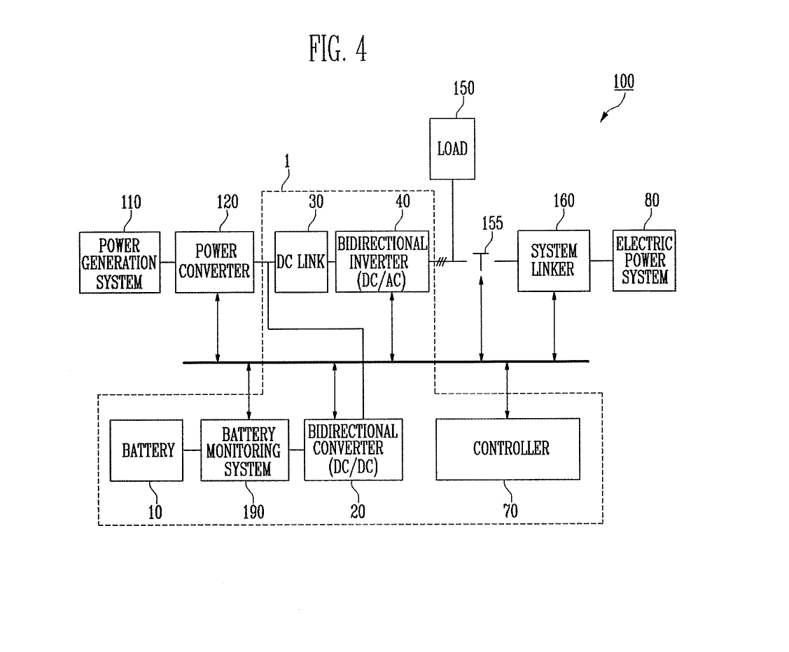

The battery 10 may be coupled to the bidirectional converter 20 through a battery monitoring system 190, to be discussed in greater detail below with reference to FIG. 4. In this case, the bidirectional converter 20 may be implemented as an isolated bidirectional converter.

The DC link 30 may perform a function of temporarily storing DC power output from the bidirectional converter 20 and transmitting the stored power to another component (e.g., a bidirectional inverter 40). In this case, the DC link 30 may perform a function of storing DC power output from the bidirectional inverter 40 and transmitting the stored power to the bidirectional converter 20. The bidirectional inverter 40 may convert DC power from the DC link 30 into AC power and output the converted AC power to an electric power system 80 or other device or power network.

The controller 70 may heat the battery 10 by controlling the bidirectional converter 20 during a battery heating mode Tcd, so that the battery 10 can be normally operated.

In accordance with one embodiment, when the power conversion device 1 enters into the battery heating mode Tcd, the controller 70 may control the bidirectional converter 20 so that the battery 10 repeats charging and discharging during the battery heating mode Tcd. For example, as shown in FIG. 2, charging and discharging operations of the battery 10 may be repetitively performed during the battery heating mode Tcd. As the charging and discharging operations are repetitively performed, the temperature of the battery 10 is increased.

The presence of entering into the battery heating mode Ted from a general driving mode may be determined according to the temperature of the battery 10. To this end, the power conversion device according to this embodiment may further include a temperature sensor 60. The temperature sensor 60 performs a function of measuring a temperature of the battery 10. The temperature sensor 60 may transmit information indicative of the measured temperature to the controller 70.

Accordingly, the controller 70 can determine when to enter into the battery heating mode Tcd according to the measured temperature of the battery 10. For example, in a case where the temperature of the battery 10 is at a predetermined first reference value or less, the controller 70 may perform the battery heating mode Tcd. In a case where the temperature of the battery 10 exceeds the predetermined first reference value, the controller 70 may perform a general or normal driving mode.

In a case where the temperature of the battery 10, measured by the temperature sensor 60, corresponds to a predetermined second reference value or more after the power conversion device 1 enters into the battery heating mode Tcd, the controller 70 may end the battery heating mode Tcd and return to the general or normal driving mode.

That is, in a case where the battery 10 is heated to a temperature at which the battery 10 can be normally operated, the operation of heating the battery 10 is not required any more. Therefore, the battery heating mode Tcd is preferably finished. In this case, the second reference value may be a value higher than the first reference value.

Although it has been illustrated in FIG. 2 that each of the charging and discharging is repeated four times during the battery heating mode Tcd, the number of times of charging and discharging may be variously changed. In another embodiment, one of the charging operation or discharging operation may be performed during the battery heating mode. For example, if the battery charge is low, the controller 70 may control a charging operation to be performed for a predetermined time period and/or until a predetermined amount of charge is stored in the battery. As a result of the charging operation, the battery temperature may increase to a level corresponding to the general or normal driving mode. Conversely, if a large amount of charge is stored in the battery, the controller may control a discharging operation to be performed for a predetermined time period or until a predetermined amount of charge is stored in the battery. The discharging operation may also raise the temperature of the battery to allow for general or normal driving mode operation.

In another embodiment, the charging operation or discharging operation may be selectively performed, for example, based on battery charge and may be terminated based on one or more of battery temperature, current, or voltage or after a predetermined time period.

FIG. 3 illustrates one embodiment of bidirectional converter 20 which includes a first circuit 21, a second circuit 22, and a transformer 50. The first circuit 21 may be coupled to the battery 10. The second circuit 22 may be coupled to the DC link 30. The transformer 50 may be coupled between the battery and the DC link 30. For example, the transformer may be coupled between the first circuit 21 and the second circuit 22.

During a discharging period Pd in the battery heating mode Tcd, the first circuit 21 may convert DC voltage of the battery 10 into AC voltage and then supply the converted AC voltage to the transformer 50. The second circuit 22 may convert AC voltage of the transformer 50 into DC voltage and then supply the converted DC voltage to the DC link 30. Accordingly, a discharging operation of the battery 10 is performed during the discharging period Pd.

During a charging period Pc in the battery heating mode Tcd, the second circuit 22 may convert DC voltage of the DC link into AC voltage and then supply the converted AC voltage to the transformer 50. The first circuit 21 may convert AC voltage of the transformer 50 into DC voltage and then supply the converted DC voltage to the battery 10. Accordingly, a charging operation of the battery 10 is performed during the charging period Pc.

Referring to FIG. 3, the first circuit 21 may include a first inductor L1, a first switching element M1, a second switching element M2, a third switching element M3, and a fourth switching element M4.

The first inductor L1 may be coupled to the battery 10, e.g., one end of the first inductor L1 may be coupled to a positive (+) electrode of the battery and the other end may be coupled to the first and third switching elements M1 and M3.

The first switching element M1 may be coupled between the first inductor L1 and a first node N1. The second switching element M2 may be coupled between the first node N1 and a ground power source. The third switching element M3 may be coupled between the first inductor L1 and a second node N2. The fourth switching element M4 may be coupled between the second node N2 and the ground power source.

Additionally, a first electrode of the first switching element M1 may be coupled to the first inductor L1. A second electrode of the first switching element M1 may be coupled to the first node N1. A control electrode of the first switching element M1 may be coupled to the controller 70.

A first electrode of the second switching element M2 may be coupled to the first node N1. A second electrode of the second switching element M2 may be coupled to the ground power source. A control electrode of the second switching element M2 may be coupled to the controller 70.

A first electrode of the third switching element M3 may be coupled to the first inductor L1. A second electrode of the third switching element M3 may be coupled to the second node N2. A control electrode of the third switching element M3 may be coupled to the controller 70.

A first electrode of the fourth switching element M4 may be coupled to the second node N2. A second electrode of the fourth switching element M4 may be coupled to the ground power source. A control electrode of the fourth switching element M4 may be coupled to the controller 70.

Recovery diodes D1, D2, D3 and D4 may be coupled in parallel to the switching elements M1, M2, M3 and M4, respectively. For example, a first recovery diode D1 may be coupled in parallel to the first switching element M1. A second recovery diode D2 may be coupled in parallel to the second switching element M2. A third recovery diode D3 may be coupled in parallel to the third switching element M3. A fourth recovery diode D4 may be coupled in parallel to the fourth switching element M4.

More specifically, an anode of the first recovery diode D1 may be coupled to the second electrode of the first switching element M1. A cathode of the first recovery diode D1 may be coupled to the first electrode of the first switching element M1.

An anode of the second recovery diode D2 may be coupled to the second electrode of the second switching element M2. A cathode of the second recovery diode D2 may be coupled to the first electrode of the second switching element M2.

An anode of the third recovery diode D3 may be coupled to the second electrode of the third switching element M3. A cathode of the third recovery diode D3 may be coupled to the first electrode of the third switching element M3.

An anode of the fourth recovery diode D4 may be coupled to the second electrode of the fourth switching element M4. A cathode of the fourth recovery diode D4 may be coupled to the first electrode of the fourth switching element M4.

Referring to FIG. 3, the second circuit 22 may include a fifth switching element M5, a sixth switching element M6, a seventh switching element M7, and an eighth switching element M8. The fifth switching element M5 may be coupled between the DC link 30 and a third node N3. The sixth switching element M6 may be coupled between the third node N3 and the ground power source. The seventh switching element M7 may be coupled between the DC link 30 and a fourth node N4. The eighth switching element M8 may be coupled between the fourth node N4 and the ground power source. On-off operations of each switching element M5, M6, M7 or M8 may be controlled by the controller 70.

In one embodiment, a first electrode of the fifth switching element M5 may be coupled to a positive (+) terminal of the DC link 30. A second electrode of the fifth switching element M5 may be coupled to the third node N3. A control electrode of the fifth switching element M5 may be coupled to the controller 70.

A first electrode of the sixth switching element M6 may be coupled to the third node N3. A second electrode of the sixth switching element M6 may be coupled to the ground power source. A control electrode of the sixth switching element M6 may be coupled to the controller 70.

A first electrode of the seventh switching element M7 may be coupled to the positive (+) terminal of the DC link 30. A second electrode of the seventh switching element M7 may be coupled to the fourth node N4. A control electrode of the seventh switching element M7 may be coupled to the controller 70.

A first electrode of the eighth switching element M8 may be coupled to the fourth node N4. A second electrode of the eighth switching element M8 may be coupled to the ground power source. A control electrode of the eighth switching element M8 may be coupled to the controller 80.

Recovery diodes D5, D6, D7 and D8 may be coupled in parallel with the switching elements M5, M6, M7 and M8, respectively. For example, a fifth recovery diode D5 may be coupled in parallel to the fifth switching element M5. A sixth recovery diode D6 may be coupled in parallel to the sixth switching element M6.

A seventh recovery diode D7 may be coupled in parallel to the seventh switching element M7. An eighth recovery diode D8 may be coupled in parallel to the eighth switching element M8.

In one embodiment, an anode of the fifth recovery diode D5 may be coupled to the second electrode of the fifth switching element M5. A cathode of the fifth recovery diode D5 may be coupled to the first electrode of the fifth switching diode M5.

An anode of the sixth recovery diode D6 may be coupled to the second electrode of the sixth switching element M6. A cathode of the sixth recovery diode D6 may be coupled to the first electrode of the sixth switching element M6.

An anode of the seventh recovery diode D7 may be coupled to the second electrode of the seventh switching element M7. A cathode of the seventh recovery diode D7 may be coupled to the first electrode of the seventh switching element M7.

An anode of the eighth recovery diode D8 may be coupled to the second electrode of the eighth switching element M8. A cathode of the eighth recovery diode D8 may be coupled to the first electrode of the eighth switching element M8.

Each switching element M5, M6, M7 and M8 included in the second circuit 22 may be implemented, for example, as a transistor.

Referring to FIG. 3, the transformer 50 may be coupled between the first and second circuits 21 and 22. Specifically, a primary coil 51 of the transformer 50 may be coupled between the first and second nodes N1 and N2. A secondary coil 52 of the transformer 50 may be coupled between the third and fourth nodes N3 and N4.

The first node N1 may be a common contact of the first switching element M1, the second switching element M2, and the primary coil 51. The second node N2 may be a common contact of the third switching element M3, the fourth switching element M4, and the primary coil 51. The third node N3 may be a common contact of the fifth switching element M5, the sixth switching element M6, and the secondary coil 52. The fourth node N4 may be a common contact of the seventh switching element M7, the eighth switching element M8, and the secondary coil 52.

The controller 70 may control on-off operations of the switching elements M1 to M4 in order to perform a discharging operation of the battery 10 during the battery heating mode Tcd. For example, the controller 70 may perform turn-on and turn-off operations of the second and third switching elements M2 and M3 while maintaining the first and fourth switching elements M1 and M4 in a turn-on state during the discharging period Pd.

That is, a first period in which the first and fourth switching elements M1 and M4 may be turned on and the second and third switching elements M2 and M3 are turned on, and a second period in which the first and fourth switching elements M1 and M4 are turned on and the second and third switching elements M2 and M3 are turned off, may exist in the discharging period Pd.

The function of the first and fourth switching elements M1 and M4 may be reversed with that of the second and third switching elements M2 and M3. For example, the controller 70 may perform turn-on and turn-off operations of the first and fourth switching elements M1 and M4 while maintaining the second and third switching elements M2 and M3 in the turn-on state during the discharging period Pd.

A first period in which the second and third switching elements M2 and M3 are turned on and the first and fourth switching elements M1 and M4 are turned on, and a second period in which the second and third switching elements M2 and M3 are turned on and the first and fourth switching elements M1 and M4 are turned off, may exist in the discharging period Pd.

The first circuit 21 may form a discharging path of the battery through the operations described above. Thus, the battery 10 can be discharged during the discharging period Pd in the battery heating mode Tcd.

The second circuit 22 may perform a function of rectifying AC power transmitted from the transformer 50 through recovery diodes D5, D6, D7 and D8 and switching elements M5, M6, M7 and M8. Accordingly, the DC link 30 can be charged.

The controller 70 may control on-off operations of the switching elements M5 to M8 included in the second circuit 22 in order to perform a charging operation of the battery 10 during the battery heating mode Tcd. For example, the controller 70 may perform turn-on and turn-off operations of the sixth and seventh switching elements M6 and M7 while maintaining the fifth and eighth switching elements M5 and M8 in a turn-off state during the charging period Pc.

That is, a first period in which the fifth and eighth switching elements M5 and M8 are turned off and the sixth and seventh switching elements M6 and M7 are turned on, and a second period in which the fifth and eighth switching elements M5 and M8 are turned off and the sixth and seventh switching elements M6 and M7 are turned off, may exist in the charging period Pc.

The function of the sixth and seventh switching elements M6 and M7 may be reversed with that of the fifth and eighth switching elements M5 and M8. For example, the controller 70 may perform turn-on and turn-off of the fifth and eighth switching elements M5 and M8 while maintaining the sixth and seventh switching elements M6 and M7 in the turn-off state during the charging period Pc.

That is, a first period in which the sixth and seventh switching elements M6 and M7 are turned off and the fifth and eighth switching elements M5 and M8 are turned on, and a second period in which the sixth and seventh switching elements M6 and M7 are turned off and the fifth and eighth switching elements M5 and M8 are turned off, may exist in the charging period Pc.

The second circuit unit 22 can form a discharging path of the DC link 30 through the operations described above Thus, the DC link 30 can be discharged during the charging period Pc included in the battery heating mode Tcd. In this case, the first circuit 21 may perform a function of rectifying AC power transmitted from the transformer 50 through the recovery diodes D1, D2, D3 and D4 and the switching elements M1 to M4. Accordingly, the battery 10 can be charged.

FIG. 4 illustrates an embodiment of an energy storage system employing a power conversion device. The power conversion device may be the one shown in FIGS. 1, 2, and 3, or may be a different device.

Referring to FIG. 4, the energy storage system 100 may include a power conversion device 1, a power generation system 110, a power converter 120, a load 150, a system linker 160, and an electric power system 80.

The power generation system 110 generates electrical energy and supplies the generated electrical energy to the energy storage system 100. In one embodiment, the power generation system 110 may be a new energy and renewable energy generation system using renewable energy including sunlight, water, subterranean heat, rainfall, living organism, etc. For example, the power generation system 110 may be a solar generation system that converts solar energy such as solar heat and sunlight into electrical energy through solar cells.

Alternatively, the power generation system 110 may be a wind power generation system for converting wind power into electrical energy, a subterranean heat generation system for converting subterranean heat into electrical energy, a hydraulic power generation system, or an ocean power generation system.

In another embodiment, the power generation system may be a new energy generation system that produces electrical energy using fuel cells or produces electrical energy using hydrogen, coal liquefied gas or medium quality residual oil gas.

The power converter 120 is coupled between the power generation system 110 and the DC link 30. The power converter 120 converts electric power generated in the power generation system 110 into DC voltage.

In one embodiment, operation of the power converter 120 is changed depending on the electric power generated in the power generation system 110. For example, in a case where the power generation system 110 generates AC voltage, the power converter 120 converts the AC voltage into DC voltage. In a case where the power generation system 110 generates DC voltage, the power converter 120 boosts or drops the DC voltage to DC voltage.

In a case where the power generation system 110 is a solar generation system, the power converter 120 may be a maximum power point tracking (MPPT) converter that detects the maximum power point according to a change in the amount of sunlight or a change in the temperature of solar heat and generates electric power. Various kinds of converters or rectifiers may be used as the power converter 120.

The DC link 30 temporarily stores DC voltage provided from the power converter 120. The DC link 30 may be, for example, a large-capacity capacitor. Thus, the DC link 30 stores stabilized DC power by removing an AC component from the DC power output from the power converter 120. In addition, the DC link 30 also stabilizes DC voltage provided from the bidirectional inverter 40 or the bidirectional converter 20 described later and temporarily stores the stabilized DC voltage.

The bidirectional inverter 40 converts the DC power from the DC link 30 into commercial AC power and outputs the converted AC power. The bidirectional inverter 40 converts DC voltage from the power generation system 110 or the battery 10 into commercial AC voltage available in a home and outputs the converted AC voltage. The bidirectional inverter 40 converts commercial AC voltage provided from the electric power system 80 into DC power and provides the converted DC power to the DC link 30. The electric power stored in the DC link 30 is provided to the battery 10 through the bidirectional converter 20.

The load 150 may be a home, industrial facility using commercial AC voltage, or another type of load. The load 150 receives commercial AC power applied from the power generation system 110, the battery 10, or the electric power system 80.

The system linker 160 couples the bidirectional inverter 40 and the electric power system 80. For example, the system linker 160 may control a voltage fluctuation range, restrict harmonics, and/or remove a DC component. The system linker 160 may provide AC power of the bidirectional inverter 40 to the electric power system 80, or may provide AC power of the electric power system 80 to the bidirectional inverter 40.

The electric power system 80 may be an AC power system provided from an electric power company or power generation company. For example, the electric power system 80 may be an electrical link formed in a wide area that includes power stations, transformer substations, and power transmission lines. The electric power system 80 may be referred to as a grid.

The battery monitoring system 190 maintains and manages the state of the battery 10. For example, the battery monitoring system 190 may monitor the voltage, current, and/or temperature of the battery 10. When an error occurs in the battery 10, the battery monitoring system 190 may warn a user of the error. In addition, the battery monitoring system 190 may calculate the state of charge (SOC) and/or state of health (SOH) of the battery 10, and may perform cell balancing of equalizing the voltage or capacity of the battery. The battery monitoring system 190 may also control a cooling fan to prevent overheating of the battery 10.

The temperature sensor 60 that measures a temperature of the battery 10 may be included in the battery monitoring system 190.

The bidirectional converter 20 converts DC power received from the DC link 30 at a first level into DC power of a second level suitable for the battery 10. The bidirectional converter 20 may also convert DC power received from the battery 10 at the second level into DC power of the first level suitable for the DC link 30.

The controller 70 monitors and controls the power converter 120, the bidirectional inverter 40, the system linker 160, and/or the bidirectional converter 20. The controller 70 may monitor the battery monitoring system 190 by communicating with the battery monitoring system 190. For example, the controller 70 may sense voltage, current, and/or temperature from one or more of the power converter 120, the bidirectional inverter 40, the system linker 160, or the bidirectional converter 20, and control the power converter 120, the bidirectional inverter 40, the system linker 160, and/or the bidirectional converter 20. In addition, the controller 70 may cut off a circuit breaker 155 coupled between the load 150 and the system linker 160 in an emergency situation.

In accordance with one or more embodiments, a power conversion device performs a battery heating function without using a separate heating device. In one embodiment, when a predetermined condition is detected, the battery heating function is performed to raise the temperature of the battery. The battery heating function may be performed by controlling one or more of a charging operation or a discharging operation of the battery. As a result, a battery at a very cold temperature or in a very cold environment may be prevented from malfunctioning or otherwise underperforming.

The predetermined condition may include a predetermined temperature. The predetermined temperature may correspond to a temperature of the battery or may correspond to an environment in which the battery is located. The environment temperature may be air or ambient temperature, or may be a temperature of another device coupled to or located proximate the battery. The temperature may correspond to one or a range of temperatures at which the battery is known to malfunction or underperform. The temperature may also be a temperature of a load coupled to the battery.

The predetermined condition may also be one of a voltage or current of the battery indicative of a malfunction or underperformance of the battery. The predetermined condition may also correspond to another type of error condition. Also, in another embodiment, a battery of a device, such as, but not limited to, a portable device, may be heated under controller of a controller.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A power conversion device, comprising:
a converter including a first circuit coupled to a battery, a second circuit coupled to a DC link, and a transformer between the first and second circuits; and
a controller to control the converter to repeatedly perform charging and discharging operations for the battery in a battery heating mode.

2. The power conversion device as claimed in claim 1, further comprising:
a temperature sensor to measure a temperature of the battery.

3. The power conversion device as claimed in claim 2, wherein the controller is to control performance of the battery heating mode based on the temperature measured by the temperature sensor.

4. The power conversion device as claimed in claim 3, wherein:
when the temperature of the battery measured by the temperature sensor corresponds to a predetermined reference value or more in the battery heating mode, the controller ends the battery heating mode.

5. The power conversion device as claimed in claim 1, wherein the first circuit includes:
a first inductor coupled to the battery;
a first switch between the first inductor and a first node;
a second switch between the first node and a reference power source;
a third switch between the first inductor and a second node; and
a fourth switch between the second node and the reference power source.

6. The power conversion device as claimed in claim 5, wherein the second circuit includes:
a fifth switch between the DC link and a third node;
a sixth switch between the third node and the reference power source;
a seventh switch between the DC link and a fourth node; and
an eighth switch between the fourth node and the reference power source.

7. The power conversion device as claimed in claim 6, wherein a primary coil of the transformer is coupled between the first and second nodes, and a secondary coil of the transformer is coupled between the third and fourth nodes.

8. The power conversion device as claimed in claim 6, wherein:
the first circuit includes a plurality of recovery diodes coupled in parallel to respective ones of the first through fourth switches, and
the second circuit includes a plurality of recovery diodes coupled in parallel to respective ones of the fifth through eighth switches.

9. The power conversion device as claimed in claim 6, wherein each of the first through eighth switches includes a transistor.

10. The power conversion device as claimed in claim 5, wherein the controller performs turn-on and turn-off operations of the second and third switches while maintaining the first and fourth switches in a turn-on state, in order to perform a discharging operation of the battery during the battery heating mode.

11. The power conversion device as claimed in claim 6, wherein the controller performs turn-on and turn-off operations of the sixth and seventh switches while maintaining the fifth and eighth switches in a turn-off state, in order to perform a charging operation of the battery during the battery heating mode.

12. The power conversion device as claimed in claim 5, wherein the controller performs turn-on and turn-off operations of the first and fourth switches while maintaining the second and third switches in the turn-on state, in order to perform the discharging operation of the battery during the battery heating mode.

13. The power conversion device as claimed in claim 6, wherein the controller performs turn-on and turn-off operations of the fifth and eighth switches while maintaining the sixth and seventh switches in the turn-off state, in order to perform the charging operation of the battery during the battery heating mode.

14. A device, comprising:
a sensor to detect a predetermined condition, and
a controller to control heating of a battery when the predetermined condition is detected by the sensor, the controller to control heating of the battery based on at least one of a battery charging operation or a battery discharging operation.

15. The device as claimed in claim 14, wherein the predetermined condition includes a predetermined temperature.

16. The device as claimed in claim 15, wherein the predetermined temperature corresponds to a temperature of the battery.

17. The device as claimed in claim 14, wherein the predetermined condition is one of a voltage or current of the battery.

18. The device as claimed in claim 14, wherein the predetermined condition is an error condition.

19. The device as claimed in claim 14, wherein the controller is to control heating of the battery by alternatively performing the charging operation and the discharging operation at least once.

20. The device as claimed in claim 14, wherein the controller is to control heating of the battery by repeatedly performing the charging operation and the discharging operation.
